(19) United States
(12) Patent Application Publication
(10) Pub. No.: US 2025/0030273 A1
(43) Pub. Date: Jan. 23, 2025

(54) DEVICE FOR WIRELESS POWER TRANSFER

(71) Applicant: Southern Methodist University, Dallas, TX (US)

(72) Inventors: Choon Sae Lee, Dallas, TX (US); Linsheng Zhang, Dallas, TX (US)

(21) Appl. No.: 18/778,110

(22) Filed: Jul. 19, 2024

Related U.S. Application Data
(60) Provisional application No. 63/514,968, filed on Jul. 21, 2023.

(51) Int. Cl. H02J 50/20; H01Q 1/36

(52) U.S. Cl. CPC H02J 50/20; H01Q 1/36

(57) ABSTRACT

An antenna for wireless power transfer is provided. The antenna includes a first conductive sheet including: (i) a first part that extends in a first direction, and (ii) a second part that extends in a second direction. The antenna includes a second conductive sheet including: (iii) a third part that is parallel to the first part and extends in the first direction, and (iv) a fourth part that is parallel to the second part and extends in the second direction. The first part and the third part are spaced apart by a first distance, and the second part and the fourth part are spaced apart by a second distance different from the first distance. The antenna also includes a dielectric layer between the first conductive sheet and the second conductive sheet. Also provided are a wireless power transfer system and a method for wireless power transfer.

### CROSS-REFERENCE TO RELATED APPLICATIONS

This application claims priority to U.S. Provisional Patent Application No. 63/514,968, filed on Jul. 21, 2023, the content of which is incorporated herein by reference.

### BACKGROUND

Antennas have been used as power coupling devices in wireless power transfer systems for a long time. In a typical wireless power transfer system, a power source provides (“feeds”) electric power to a transmitting antenna. The transmitting antenna wirelessly transfers the power to a receiving antenna coupled to a load, such as a battery of a mobile device, that consumes the power. Usually, power transfer exploits the near field coupling between two antennas spaced relatively close to each other. Conversely, wireless information transmission exploits the far field radiation properties between two antennas that are spaced relatively far from each other. The distinction between near field coupling and far field radiation has been well known and documented for decades.

### SUMMARY

In one aspect, an antenna for wireless power transfer is provided. The antenna includes a first conductive sheet including: (i) a first part that extends in a first direction, and (ii) a second part that extends in a second direction. The antenna includes a second conductive sheet including: (iii) a third part that is parallel to the first part and extends in the first direction, and (iv) a fourth part that is parallel to the second part and extends in the second direction. The antenna also includes a dielectric layer between the first conductive sheet and the second conductive sheet. The first part and the third part are spaced apart by a first distance. The second part and the fourth part are spaced apart by a second distance different from the first distance.

In some implementations, the first direction is the same as the second direction.

In some implementations, the first direction is perpendicular to the second direction.

In some implementations, the antenna includes a feeding port electrically coupled to the first conductive sheet and the second conductive sheet. The feeding port can include at least one of a coaxial port or a stripline feed.

In some implementations, the first direction is different from the second direction, the second conductive sheet further includes a fifth part that extends in the second direction, and the second part is arranged between the fourth part and the fifth part.

In some implementations, the first conductive sheet and the second conductive sheet are printed on a planar surface. The planar surface can include a printed circuit board.

In some implementations, the first conductive sheet and the second conductive sheet are metallic.

In some implementations, the dielectric layer includes air.

In another aspect, a wireless power transfer system is provided. The wireless power transfer system includes a power source that provides electric power, a transmitting antenna that wirelessly transfers to electric power, and a receiving antenna that wirelessly receives the electric power. The transmitting antenna can have features similar to those of one or more of the implementations described above.

In some implementations, a dimension of the transmitting antenna is greater than a dimension of the receiving antenna.

In yet another aspect, a method for wireless power transfer is provided. The method includes electrically coupling a feeding port to a first conductive sheet and a second conductive sheet separated by a dielectric layer. The method also includes providing electric power to the first conductive sheet and the second conductive sheet via the feeding port. The first conductive sheet and a second conductive sheet can have structures similar to those of the antenna described above.

The details of one or more implementations are set forth in the accompanying drawings and the description below. Other features, objects, and advantages of these systems and methods will be apparent from the description and drawings, and from the claims.

### BRIEF DESCRIPTION OF THE DRAWINGS

FIG. 1 illustrates an example wireless power transfer system, according to some implementations.

FIGS. 2A-2E each illustrate a cross-sectional view of an example antenna for wireless power transfer, according to some implementations.

FIG. 3 illustrates an example antenna printed on a planar surface, according to some implementations.

FIG. 4 illustrates a flowchart of an example method, according to some implementations.

The figures are not drawn to scale. Like reference numbers refer to like components.

### DETAILED DESCRIPTION

A microstrip antenna is a type of antenna with a relatively simple structure. A microstrip antenna usually has two planar conductive sheets arranged in parallel and spaced in part by dielectric material. When a microstrip antenna is properly matched (e.g., such that the return loss is minimized) and fed with a signal at a resonant frequency, the microstrip antenna can be excited to generate electric and magnetic fields at its edges.

According to the equivalence theorem and the cavity model, only the tangential components of electric field contribute to far field radiation whereas the tangential magnetic field vanishes on the edge surfaces. Therefore, the edges of a microstrip antenna are typically classified as either radiating edges or non-radiating edges. The electric field at the radiating edges is the primary contributor to far field radiation, while the electric field at the non-radiating edges contributes little to the far field radiation because the electric field is sinusoidal along the non-radiating edge with a positive value at one half section and a negative value on the other half, resulting in cancellation of the contributions from the two half sections to the far field and thus producing negligible radiation according to the equivalent theorem.

Though the tangential magnetic field at the non-radiating edges is vanishly small, the normal component of magnetic field near the non-radiating edges is relatively strong, which can be exploited to provide effective near field coupling with another device for wireless power transfer. With the co-existing radiation, however, there are design challenges to improving the coupling efficiency by, e.g., increasing the proportion of near field energy transfer over the total energy fed to the microstrip antenna. In view of these design challenges, implementations of this disclosure provide antenna structures with improved coupling efficiency for wireless power transfer.

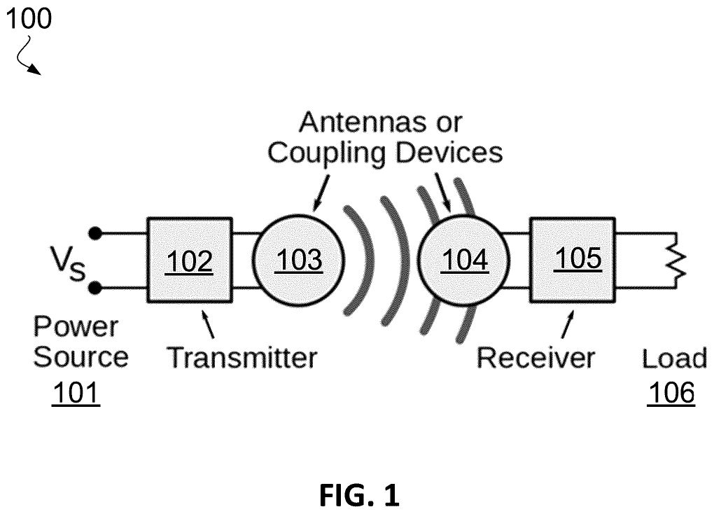

FIG. 1 illustrates an example wireless power transfer system 100, according to some implementations. Wireless power transfer system 100 can be applied to many applications, such as wirelessly charging a mobile device or an electric vehicle.

On the transmission side of wireless power transfer system 100, power source 101 provides, via transmitter circuit 102, to antenna (or, more generally, coupling device) 103. Power source 101 can include or be connected to, e.g., a generator, a power outlet, or power grid. To provide electric power, power source 101 can provide an electric signal, which can be a direct current (DC) signal, an alternating current (AC) signal, a pulse signal, a modulated signal, or a combination thereof.

Transmitter circuit 102 can include converting circuitry that converts the signal from power source 101 to a form that antenna 103 is capable of transmitting. For example, transmitter 102 can include a modulation circuit, an amplifier circuit, a rectifier circuit, or a DC-to-AC converter (DAC) to generate an input signal to antenna 103. Transmitter 102 can also include impedance matching circuit that matches the input impedance of antenna 103 according to the frequency of the input signal.

On the reception side of wireless power transfer system 100, antenna 104 receives electric power transferred from antenna 103 via near field coupling. Antenna 104 then provides, via receiver circuit 105, the electric power to load 106, which can be, e.g., a mobile device or an electric vehicle.

Receiver circuit 105 can include converting circuitry that converts the received signal to a form that load 106 is capable of consuming. For example, receiver circuit 105 can include a demodulation circuit, an amplifier circuit, a rectifier circuit, and/or an AC-to-DC converter (ADC) to generate an output signal to load 105. In some implementations, receiver circuit 105 further includes heat dissipation components, such as one or more metal plates or cooling liquid pipelines, that dissipate excess power caused by wireless power transfer to prevent load 106 from overheating.

Antennas 103 and 104 can be structured similarly to each other, with the same or different dimensions. For example, antenna 103 can be made multiple times the size of antenna 104 to increase power transfer efficiency (e.g., the percentage of power received by antenna 104 over the total power provided by power source 101).

In wireless power transfer systems such as system 101, the coupling efficiency of an antenna is directly correlated to the Q factor of the antenna. According to the coupled-mode theory, the higher Q factor, the less the antenna's radiation performance and hence the more efficient the antenna's coupling performance. With the strength of magnetic field excited on the non-radiating edges of an antenna being the same, the Q factor can be increased by reducing the length of the non-radiating edges, which in turn increases the radiating efficiency. For example, by narrowing the non-radiating edges of a microstrip antenna from 47 millimeters (mm) to 5 mm, the radiating efficiency can be increased from about 5.4% to 41.1%. However, the non-radiating edges cannot be narrowed infinitely because that would make impedance matching very difficult. Accordingly, a balance is needed between improving the coupling efficiency of a microstrip antenna and maintaining impedance matching.

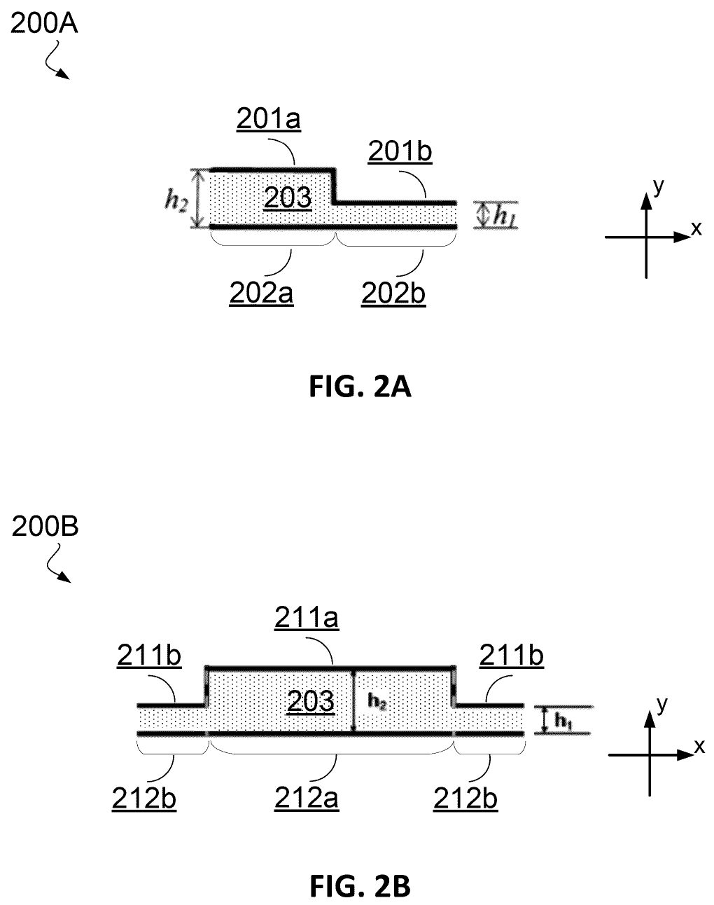

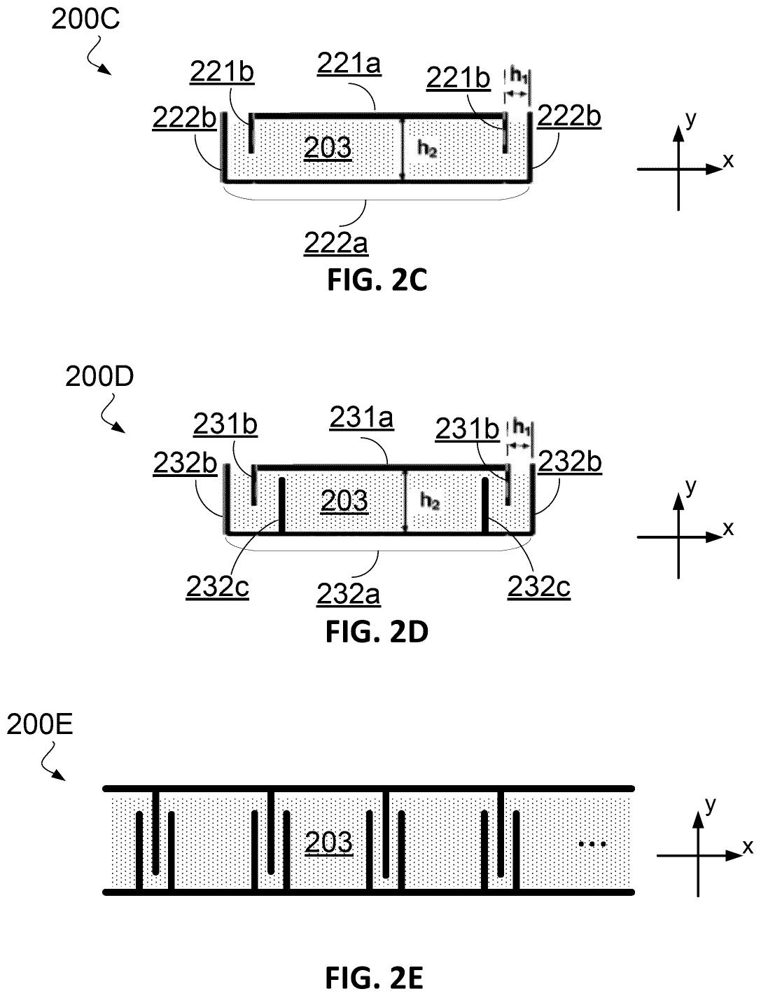

In addition to narrowing the non-radiating edges, one can increase the Q-factor of an antenna by making the antenna electrically smaller. An antenna is electrically small if the size of the antenna is much smaller than the free-space wavelength of the signal transmitted by the antenna. Generally, when the resonant frequency of the antenna decreases, the antenna becomes electrically smaller, so the Q-factor increases due to radiation reduction. As described below, implementations according to FIGS. 2A-2E introduce height discontinuity to the conventional microstrip antenna structures. Compared to conventional microstrip antennas, the height discontinuity adds extra boundary conditions to the excitation of electromagnetic fields, which can lead to reduced resonant frequency and increased Q-factor, thereby improving coupling efficiency.

FIGS. 2A-2E each illustrate a cross-sectional view of an example antenna, 200A-200E, respectively, for wireless power transfer, according to some implementations. Each of antennas 200A-200E has two conductive sheets, such as two metallic foils, separated by dielectric material, such as air, flame retardant (FR)-4 substrate, or RO4003C laminate. While this structure is similar to regular microstrip antennas, the distance between the two conductive sheets is not uniform within each of antennas 200A-200E, which results in a height discontinuous structure. Each of antennas 200A-200E can be implemented as antennas 103 and/or 104 of FIG. 1. When in operation, each of antennas 200A-200E can receive electric power via a feeding port (not shown in FIGS. 2A-2E), such as a coaxial port and/or a stripline feed, that is electrically coupled to the first conductive sheet and the second conductive sheet.

In FIG. 2A, antenna 200A has a first conductive sheet formed by first part 201a and second part 201b. Both first part 201a and second part 201b extend in the x direction and are parallel to each other. Antenna 200A also has a second conductive sheet formed by third part 202a and fourth part 202b. Both third part 201a and fourth part 201b also extend in the x direction and are parallel to each other. Between the two conductive sheets is dielectric layer 203.

In some examples, the distance between the two conductive sheets is not uniform. As shown in FIG. 2A, first part 201a and third part 202a are spaced by distance h₂ while second part 201b and fourth part 202b are spaced by distance h₁, where h₁ is different from h₂. The transition between parts 201a and 201b is not continuous. Compared to a conventional microstrip antenna, the discontinuity can effectively reduce the resonant frequency and make antenna 200a electrically smaller than the conventional microstrip antenna.

In FIG. 2B, antenna 200B has a first conductive sheet formed by first part 211a and second part 211b. Both first part 211a and second part 211b extend in the x direction. Antenna 200B also has a second conductive sheet formed by third part 212a and fourth part 212b. Both third part 201a and fourth part 201b also extend in the x direction. Between the two conductive sheets is dielectric layer 203. First part 211a and third part 212a are spaced by distance h₂ while second part 211b and fourth part 212b are spaced by distance h₁, where h₁ is different from h₂.

Antenna 200B differs from antenna 200A in that second part 211b has two instances, respectively distributed on the left side and the right side of first part 211a. Correspondingly, fourth part 212b has two instances respectively distributed on the left side and the right side of first part 212a. Despite this difference, the height discontinuity in antenna 200B is consistent with that in antenna 200B.

In FIG. 2C, antenna 200C has a first conductive sheet formed by first part 221a and two instances of second part 221b. First part 221a extends in the x direction while second part 221b extends in the y direction, perpendicular to the x direction. Antenna 200C also has a second conductive sheet formed by third part 222a and two instances of second part fourth part 222b. Third part 222a extends in the x direction while fourth part 222b extends in the y direction. Between the two conductive sheets is dielectric layer 203.

The structure of antenna 200C can be considered a regular microstrip antenna with edges of two flat sheets bent toward the other sheet. In such a structure, first part 221a and third part 222a are spaced apart by distance h₂ while each instance of second part 221b and a corresponding instance of fourth part 222b are spaced apart by distance h₁, where h₁ is different from h₂. Although parts 221b and 222b extend in a direction different from parts 221a and 222a, the height discontinuity in antenna 200C is consistent with those in antennas 200A and 200B.

In FIG. 2D, antenna 200D has a structure similar to that of antenna 200C of FIG. 2C. For example, antenna 200D has a first conductive sheet formed by first part 231a and two instances of second part 231b. First part 231a extends in the x direction while second part 231b extends in the y direction. Antenna 200D also has a second conductive sheet formed by third part 232a and two instances of fourth part 232b. Third part 232a extends in the x direction while fourth part 232b extends in the y direction. Between the two conductive sheets is dielectric layer 203. First part 231a and third part 232a are spaced apart by distance h₂ while each instance of second part 231b and a corresponding instance of fourth part 232b are spaced apart by distance h₁, where h₁ is different from h₂.

The second conductive sheet of antenna 200D additionally has two instances of fifth part 232c. Fifth part 232c also extends in the y direction, parallel to second part 231b and fourth part 232b. As shown in FIG. 2D, each instance of second part 231b is arranged between a corresponding instance of fourth part 232b and a corresponding instance of fifth part 232c, creating a fin structure. The distance between an instance of fifth part 232c and a corresponding instance of second part 231b can be similar to h₁. Despite the introduction of fifth part 232c in antenna 200D, the height discontinuity in antenna 200D is consistent with those in antennas 200A-200C.

In FIG. 2E, antenna 200E has a structure similar to that of antenna 200D. For example, antenna 200E also has two conductive sheets and dielectric layer 203 in between. The conductive sheets form multiple instances of fin structure along the x direction, with each instance of the fin structure being similar to that illustrated in FIG. 2D.

Distances h₁ and h₂ can differ considerably to provide the desired level of resonance frequency reduction. In some implementations according to antennas 200A-200E, the ratio of h₁/h₂ is about ⅛. However, this ratio is not limiting and other examples are possible. Further, the ratio of h₁/h₂ can vary and be adjustable within the same antenna.

FIGS. 2A-2E illustrate a limited number of many implementations of antennas with height discontinuity. From the description of these examples, a person ordinarily skilled in the art would have readily understood that other variations are possible. For example, some implementations can have the second part and the fourth part extend in a direction that is neither parallel nor perpendicular to the direction of the first part and the third part. Also, some implementations can have multiple levels of height discontinuity (e.g., multiple values of h₁) within the same antenna. Additionally, some implementations can be structured to have a combination of features of some or all of antennas 200A-200E.

The structures of antennas 200A-200E can be similarly applied to antennas printed on planar surfaces, such as printed circuit boards (PCBs). For example, metallic wire can be printed (e.g., by etching process) on a PCB surface with a routing layout corresponding to the conductive sheets of one or more of antennas 200A-200E, whereas the non-conductive portion on the PCB surface can serve as the dielectric layer. With the antennas printed on a two-dimensional surface, a wireless power transfer system can have reduced space compared to systems that use antennas 200A-200E, which have three-dimensional structures. The space saving can reduce the complexity and cost of antenna fabrication and make the wireless power transfer system more suitable for devices that are size-sensitive.

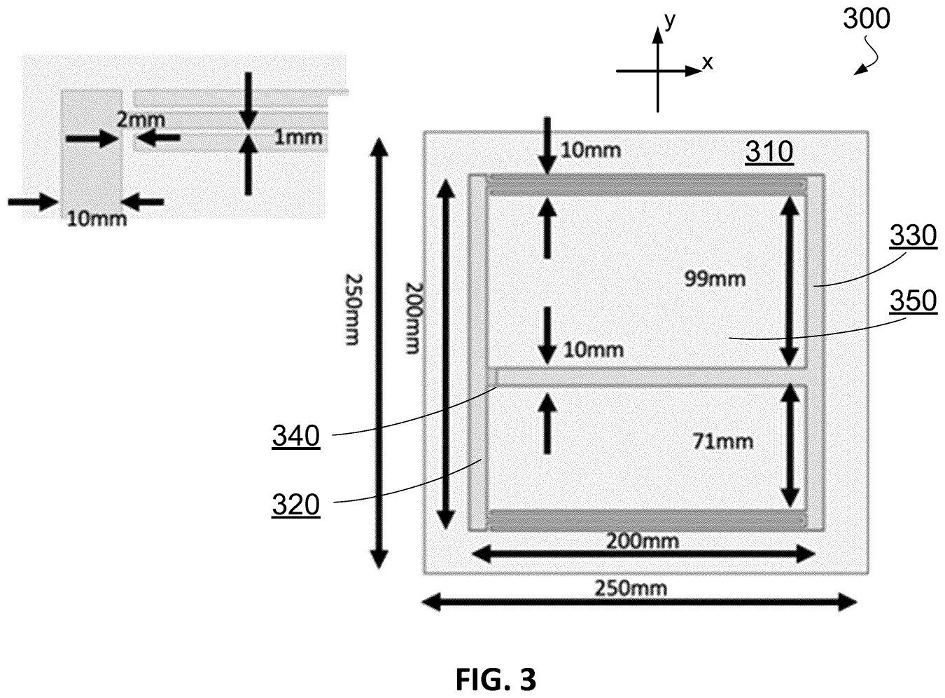

FIG. 3 illustrates an example antenna 300 printed on a planar surface, according to some implementations. In some examples, antenna 300 is printed on PCB 310 with a size of 250 mm×250 mm. Antenna 300 has a first conductive sheet 320 and second conductive sheet 330, which are spaced apart by dielectric material 350 and coupled to feeding port 340.

Conductive sheets 320 and 330 are routed similar to the structure of antenna 200C of FIG. 2D. For example, along the y direction, conductive sheets 320 and 330 have a first part and a third part, respectively, that have a length of 200 mm and a width of 10 mm (see the magnified view on the upper left corner of FIG. 3). Along the x direction, conductive sheet 320 has two instances of a second part that extends toward conductive sheet 330. Similarly, conductive sheet 320 has two instances of a fourth part and two instances of a fifth part that both extend toward conductive sheet 320. Accordingly, antenna 300 has two instances of fin structure similar to that of antenna 200C. The PCB area occupied by the routing of conductive sheets 320 and 330 is approximately 200 mm×200 mm.

Furthermore, as illustrated in FIG. 3, feeding port 340 has a distance from the upper instance of the fin structure of about 99 mm and a distance from the lower instance of the fin structure of about 71 mm. In PCB design, the location of a feeding port of a printed antenna can be determined and optimized based on the overall antenna dimensions, the input impedance, and the frequency of the transmitted signal.

In some other wireless power transfer techniques, coils are printed on PCB boards to serve as coupling devices. According to these techniques, electric power is transferred from the mutual inductance excited between the transmitting coil and the receiving coil. Such mechanisms of power transfer typically require a matching capacitor on the transmitter side such that the power from the power source can properly excite inductance on the transmitting coil. Similarly, such mechanisms typically require a matching capacitor on the receiver side such that the power received by the receiving coil can properly converted to signals to drive the load. Compared to those techniques, implementations similar to antenna 300 print antennas with height discontinuity—instead of coils—as coupling devices to transfer power. The elimination of coils in turn allows the elimination of matching capacitors, which can advantageously reduce fabrication complexity and cost.

In some implementations, it is desirable to make the radiation unidirectional (when the antenna is used as a transmitting antenna) or receive power from one side of the device (when the antenna is used as a receiving antenna). Some implementations are described below with reference to FIG. 3, assuming antenna 300 is a used as a transmitting antenna.

In the example of FIG. 3, assuming z direction is perpendicular to the x-y plane of FIG. 3, unidirectional radiation can mean that all or most of the radio energy is emitted toward a radiating direction (e.g., either one of the z direction and the −z direction) while little radio energy is emitted toward the non-radiating direction (e.g., the other one of the z direction and the −z direction). To make antenna 300 unidirectional, it is possible to place a back plate substantially parallel with PCB 310 at the non-radiating side of PCB 310. This way, radio waves emitted from the non-radiating side of PCB 310 are reflected by the back plate. By using a conductive back plate which phase-shifts the incident waves by about 90 degrees, and by placing the back plate at a distance that equals a quarter wavelength of the radio waves, the reflected radio waves can constructively interfere with the emitted radio waves such that the emission is mostly cancelled by the reflection. This could effect virtually no radiation in the non-radiating direction.

In some implementations where unidirectional radiation (or likewise, unidirectional reception) is desired, the quarter wavelength separation distance between PCB 310 and the back plate would make the overall antenna assembly too large. In view of this, an artificial surface with a predetermined surface impedance can be used in lieu of the conductive back plate.

For example, a back plate having a perfect or close-to-perfect magnetic surface or a fine mesh surface (e.g., a mesh surface made of conductor) can be used. After reflection by such back plate surface, the reflected waves have a phase shift close to zero degree from the incident waves, instead of a phase shift of 90 degrees as by a perfect conductor. Accordingly, the separation distance between PCB 310 and the back plate can be reduced or eliminated instead of quarter wavelength, which in turn reduces the size of the overall antenna assembly. More generally, the material of the back plate can be configured with an impedance that corresponds to a desired phase shift, which further translates to the desired separate distance between the antenna and the back plate. As such, the antenna assembly can advantageously be made more compact.

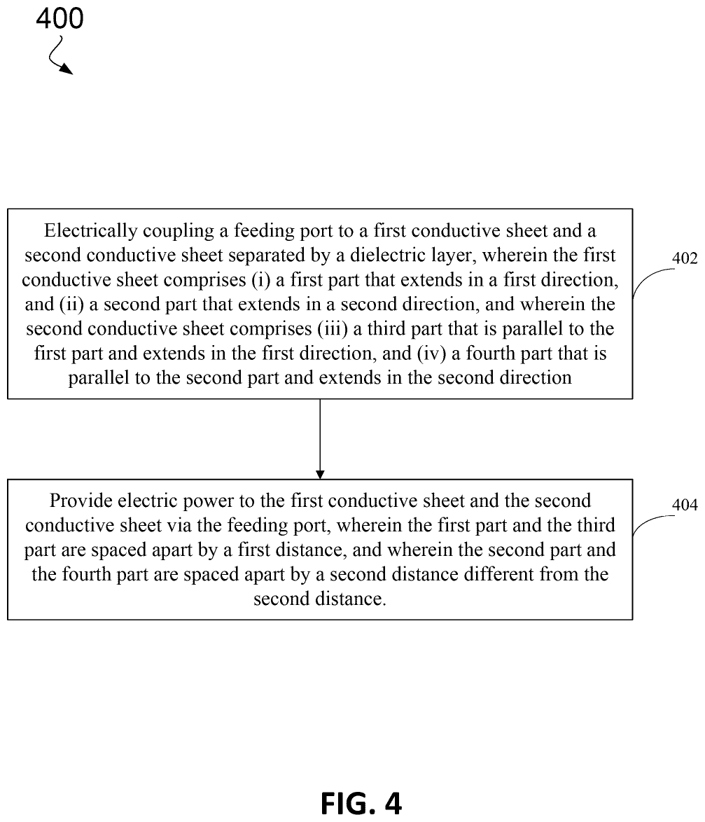

FIG. 4 illustrates a flowchart of an example method 400, according to some implementations. It will be understood that method 400 can be performed, for example, during a design phase using simulation software, during a testing phase in a laboratory environment, during a fabrication phase in a factory, or in practical wireless transfer applications.

At 402, method 400 involves electrically coupling a feeding port to a first conductive sheet and a second conductive sheet separated by a dielectric layer. The first conductive sheet includes (i) a first part that extends in a first direction, and (ii) a second part that extends in a second direction. The second conductive sheet includes (iii) a third part that is parallel to the first part and extends in the first direction, and (iv) a fourth part that is parallel to the second part and extends in the second direction. These arrangements can be similar to those described previously with reference to FIGS. 2A-3.

At 404, method 400 involves providing electric power to the first conductive sheet and the second conductive sheet via the feeding port. The electric power can be provided by, e.g., power source 101 of FIG. 1. To wirelessly transfer the electric power using an antenna, the first part and the third part are spaced apart by a first distance, and the second part and the fourth part are spaced apart by a second distance different from the second distance.

While this specification includes many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

The previously described example implementations do not define or constrain the present disclosure. Other changes, substitutions, and alterations are also possible without departing from the spirit and scope of the present disclosure.

What is claimed is:

1. An antenna for wireless power transfer, comprising:
a first conductive sheet comprising: (i) a first part that extends in a first direction, and (ii) a second part that extends in a second direction;
a second conductive sheet comprising: (iii) a third part that is parallel to the first part and extends in the first direction, and (iv) a fourth part that is parallel to the second part and extends in the second direction, wherein the first part and the third part are spaced apart by a first distance, and wherein the second part and the fourth part are spaced apart by a second distance different from the first distance; and
a dielectric layer between the first conductive sheet and the second conductive sheet.

2. The antenna of claim 1, wherein the first direction is the same as the second direction.

3. The antenna of claim 1, wherein the first direction is perpendicular to the second direction.

4. The antenna of claim 1, further comprising a feeding port electrically coupled to the first conductive sheet and the second conductive sheet.

5. The antenna of claim 4, wherein the feeding port comprises at least one of: a coaxial port, or a stripline feed.

6. The antenna of claim 1, wherein:
the first direction is different from the second direction,
the second conductive sheet further comprises a fifth part that extends in the second direction, and
the second part is arranged between the fourth part and the fifth part.

7. The antenna of claim 1, wherein the first conductive sheet and the second conductive sheet are printed on a planar surface.

8. The antenna of claim 7, wherein the planar surface comprises a printed circuit board.

9. The antenna of claim 1, wherein the first conductive sheet and the second conductive sheet are metallic.

10. The antenna of claim 1, wherein the dielectric layer comprises air.

11. A wireless power transfer system, comprising:
a power source that provides electric power;
a transmitting antenna that wirelessly transfers to electric power; and
a receiving antenna that wirelessly receives the electric power,
wherein the transmitting antenna comprises:
a first conductive sheet comprising: (i) a first part that extends in a first direction, and (ii) a second part that extends in a second direction;
a second conductive sheet comprising: (iii) a third part that is parallel to the first part and extends in the first direction, and (iv) a fourth part that is parallel to the second part and extends in the second direction, wherein the first part and the third part are spaced apart by a first distance, and wherein the second part and the fourth part are spaced apart by a second distance different from the first distance; and
a dielectric layer between the first conductive sheet and the second conductive sheet.

12. The wireless power transfer system of claim 11, wherein the first direction is the same as the second direction or perpendicular to the second direction.

13. The wireless power transfer system of claim 11, further comprising a back plate separated from the transmitting antenna in a non-radiating direction, wherein the back plate is configured to reflect a radio wave emitted by the transmitting antenna with a predetermined phase shift between the reflected radio wave and an incident wave.

14. The wireless power transfer system of claim 11, wherein the back plate comprises at least one of:
a close-to-perfect magnetic conductor, or a mesh surface that is made of conductor.

15. The wireless power transfer system of claim 11, wherein the transmitting antenna further comprises a feeding port electrically coupled to the first conductive sheet and the second conductive sheet.

16. The wireless power transfer system of claim 11, wherein
the first direction is different from the second direction,
the second conductive sheet further comprises a fifth part that extends in the second direction, and
the second part is arranged between the fourth part and the fifth part.

17. The wireless power transfer system of claim 11, wherein the first conductive sheet and the second conductive sheet are printed on a planar surface.

18. The wireless power transfer system of claim 17, wherein the planar surface comprises a printed circuit board.

19. The wireless power transfer system of claim 11, wherein a dimension of the transmitting antenna is greater than a dimension of the receiving antenna.

20. A method for wireless power transfer, comprising:
electrically coupling a feeding port to a first conductive sheet and a second conductive sheet separated by a dielectric layer, wherein the first conductive sheet comprises (i) a first part that extends in a first direction, and (ii) a second part that extends in a second direction, and wherein the second conductive sheet comprises (iii) a third part that is parallel to the first part and extends in the first direction, and (iv) a fourth part that is parallel to the second part and extends in the second direction; and
providing electric power to the first conductive sheet and the second conductive sheet via the feeding port,
wherein the first part and the third part are spaced apart by a first distance, and
wherein the second part and the fourth part are spaced apart by a second distance different from the second distance.
